(19) United States
(12) Patent Application Publication
(10) Pub. No.: US 2024/0167862 A1
(43) Pub. Date: May 23, 2024

(54) Air Mass Sensor and Motor Vehicle

(71) Applicant: Vitesco Technologies GmbH, Regensburg (DE)

(72) Inventors: Martin Lesser, Landshut (DE); Andreas Meyer, Zell (DE); Holger Weininger, Painten (DE); Marion Heiss, München (DE); Thomas Millies, Regensburg (DE); Radim Sotkovsky, Frydek-Mistek (CZ); Petr Kusyn, Hlucin (CZ)

(73) Assignee: Vitesco Technologies GmbH, Regensburg (DE)

(21) Appl. No.: 18/552,548

(22) PCT Filed: Mar. 17, 2022
(86) PCT No.: PCT/EP2022/056937

§ 371 Date: Sep. 26, 2023

(30) Foreign Application Priority Data
Mar. 30, 2021 (DE) 10 2021 203 219.2

(51) Int. Cl. G01F 5/00; G01F 1/692

(52) U.S. Cl. CPC G01F 5/00; G01F 1/692

(57) ABSTRACT

Various teachings of the present disclosure include an air mass sensor for determining an air mass flow rate. The sensor may include: a housing defining a chamber; sensor electronics at least partly located in the chamber; a duct passing an air mass flow through the housing to be measured, the duct comprising an inlet port and an outlet port; and at least one compensation port connecting the duct to surroundings external to the housing.

### CROSS-REFERENCE TO RELATED APPLICATIONS

This application is a U.S. National Stage Application of International Application No. PCT/EP2022/056937 filed Mar. 17, 2022, which designates the United States of America, and claims priority to DE Application No. 10 2021 203 219.2 filed Mar. 30, 2021, the contents of which are hereby incorporated by reference in their entirety.

### TECHNICAL FIELD

The present disclosure relates to sensors. Various embodiments of the teachings herein include an air mass sensor for determining an air mass flow and/or a motor vehicle comprising an air mass sensor.

### BACKGROUND

An air mass sensor is described, for example, from documents U.S. Pat. No. 8,763,452 B2 and DE 10 2018 219 729 A1. Such an air mass sensor can be used, for example, to determine an air mass flow in an intake duct of an internal combustion engine of a motor vehicle. In this case, oscillation excitations can occur in the range of the natural frequencies of the duct and compromise the measurement result. For example, an exhaust gas turbocharger can cause high-frequency pressure pulsations of up to 20 kHz in the air mass flow to be measured. For certain excitation frequencies or excitation frequency ranges, there may thus be large deviations between the measured air mass flow and the actual air mass flow. These deviations can have a detrimental effect on engine operation.

### SUMMARY

Against this background, the present disclosure addresses the technical problem of an air mass sensor which, in particular, is more robust with respect to vibration excitations from exhaust gas turbochargers. For example, some embodiments of the teachings herein include an air mass sensor for determining an air mass flow rate, comprising a housing (4) and comprising sensor electronics (6), wherein the sensor electronics is at least partly located in a housing chamber (8) of the housing (4), wherein the housing (4) has a duct (14) for passing through the housing (4) an air mass flow (L) to be measured, characterized in that in addition to an inlet port (16) and an outlet port (18) of the duct (14), the housing (4) has at least one compensation port (26, 32) which connects the duct (14) to surroundings (U) of the housing (4).

In some embodiments, the compensation port (26) is formed between housing parts (12, 29) of the housing (4).

In some embodiments, the housing parts (12, 29) are connected to one another by means of an adhesive (34), wherein the compensation port (26) at least partially borders an adhesive (34) connecting the housing parts (12, 29).

In some embodiments, the compensation port (26) is part of an interrupted adhesive seam (34) or interrupted adhesive bead.

In some embodiments, a seal (34) is provided between the housing parts (12, 29), wherein the compensation port (26) at least partially borders the seal (34).

In some embodiments, the compensation port (26) is introduced into the seal (34) or the seal (34) is at least partially interrupted to form the compensation port (26).

In some embodiments, the compensation port (26) is arranged in the region of the inlet (16) of the duct (14), in particular is arranged upstream of a branching of the duct (14) into a measuring channel (30) and a bypass channel (20).

In some embodiments, the compensation port (26) has a polygonal shape, in particular a rectangular or triangular shape, or the compensation port (26) has a circular or oval shape, or two or more compensation ports (26) are provided.

As another example, some embodiments include a motor vehicle characterized by an air mass sensor (2) as described herein.

In some embodiments, the motor vehicle as further comprises an internal combustion engine (110), characterized in that the air mass sensor (2) is arranged in an intake line (120) of the internal combustion engine (110) to measure an air mass flow within the intake line (120).

### BRIEF DESCRIPTION OF THE DRAWINGS

The teachings of the present disclosure are described in greater detail below with reference to a drawing illustrating exemplary embodiments. In the figures, in each case highly schematically:

FIG. 1 shows a perspective view from above of an air mass sensor incorporating teachings of the present disclosure;

FIG. 2 shows the air mass sensor from FIG. 1 without covers or lids;

FIG. 3 shows a further embodiment of an air mass sensor incorporating teachings of the present disclosure;

FIG. 4 shows a further embodiment of an air mass sensor incorporating teachings of the present disclosure;

FIG. 5 shows a further embodiment of an air mass sensor incorporating teachings of the present disclosure;

FIG. 6 shows a further embodiment of an air mass sensor incorporating teachings of the present disclosure;

FIG. 7 shows a further embodiment of an air mass sensor incorporating teachings of the present disclosure;

FIG. 8 shows a further embodiment of an air mass sensor incorporating teachings of the present disclosure;

FIG. 9 shows a further embodiment of an air mass sensor incorporating teachings of the present disclosure without covers or lids;

FIG. 10 shows the air mass sensor from FIG. 9 in an enlarged representation; and

FIG. 11 shows a motor vehicle with an air mass sensor incorporating teachings of the present disclosure.

### DETAILED DESCRIPTION

An example air mass sensor for determining an air mass flow incorporating teachings of the present disclosure may include a housing and sensor electronics, wherein the sensor electronics is at least partly located in a housing chamber of the housing, and wherein the housing has a duct for guiding an air mass flow to be measured through the housing. The air mass sensor is distinguished in that the housing has, in addition to an inlet port and an outlet port of the duct, at least one compensation port which connects the duct to surroundings of the housing.

The compensation port enables a fluid connection between the duct and the surroundings of the housing, so that part of the air mass flow to be measured can flow out of the duct into the surroundings of the housing to create an additional pressure compensation. In this way, in particular, the amplitude of oscillation excitations due to high-frequency pressure pulsations of turbochargers can be reduced so that reliable measurement can also take place for critical excitation frequencies. In particular, natural frequencies of the duct can be eliminated in this way or a respective oscillation response in the range of one or more natural frequencies can be reduced.

Exactly one compensation port or two or more compensation ports can be provided.

In some embodiments, the surroundings of the housing can be an interior of a pipe, conduit, or the like, within which the air mass sensor is disposed for determining the air mass flow rate.

The compensation port can be a through-port, such as a hole or the like made in a wall of the housing.

In some embodiments, the compensation port can be formed between housing parts of the housing. Insofar as the housing has, for example, a first housing part and a second housing part which are assembled to form the housing, the compensation port can be a recess in the region of a seam or joining edge in the region of which the first and second housing parts form-fittingly engage in one another and/or are connected to one another.

The first housing part can be, for example, a lid or a cover. The second housing part can be a main body of the housing to which the cover is attached. The housing parts can be connected to each other by means of an adhesive, wherein the compensation port at least partially borders an adhesive connecting the housing parts.

In some embodiments, the compensation port is part of an interrupted adhesive seam or part of an interrupted adhesive bead. The compensation port can therefore be an interruption of an adhesive seam or adhesive bead that joins the housing parts together. In particular, the adhesive seam or adhesive bead forms an adhesive connection between the housing parts and also forms a seal between the duct and the surroundings, wherein the seal is interrupted locally to form the compensation port.

In some embodiments, a seal may be provided between the housing parts, wherein the compensation port is at least partially adjacent to the seal. The compensation port can be introduced into the seal or the seal can be at least partially interrupted to form the compensation port.

In some embodiments, the duct can have a bypass or bypass channel and a measuring channel, so that part of the air mass flow does not flow through the measuring channel to a measuring point of the air mass sensor, but is branched off into the bypass channel before the measuring point and is led out of the housing again.

In some embodiments, the compensation port can be spaced apart from the bypass channel. The compensation port can be arranged in the region of the inlet of the duct and, in particular, can be arranged upstream of a branching of the duct, in the region of which the measuring channel and the bypass channel are branched off.

In some embodiments, at least one compensation port can be provided in addition to an outlet port of the bypass channel and/or the measuring channel in a wall of the housing delimiting the bypass channel and/or the measuring channel. In this case, the compensation port is arranged downstream of the branching of the duct, in the region of which the measuring channel and the bypass channel are branched off.

“Downstream” means that the air mass flow overflows or flows through a relevant element later in time than an element arranged upstream. An inlet port of the measuring channel is therefore arranged upstream of the measuring point, while an outlet port of the measuring channel is arranged downstream of the measuring point.

In some embodiments, the compensation port can have a polygonal shape, in particular a rectangular or triangular shape. The compensation port can have a circular or oval shape. The compensation port can be freely shaped.

In some embodiments, the air mass sensor can have supplementary functions in addition to measuring an air mass flow. For example, in addition to measuring an air mass flow rate, the air mass sensor can be set up to measure one or more of the parameters listed below: pressure of the air mass flow; humidity of the air mass flow; temperature of the air mass flow.

In some embodiments, a measuring element of the sensor electronics of the air mass sensor can be a thermal measuring element, in particular a hot-film air mass measuring element. Such a hot-film air-mass measuring element can, for example, have at least one heating element and two temperature sensors which are passed over by the air mass flow, wherein the magnitude of the air mass flow can be derived from the measured temperatures or the temperature profiles of the temperature sensors, which differ from one another. Such a hot-film air mass measuring element is described, for example, in DE 10 2018 219 729 A1.

In some embodiments, components of the sensor electronics arranged in the housing or electronics chamber of the air mass sensor are at least partially or completely encapsulated in a potting compound or encased by a potting compound in order to protect the components of the sensor electronics from environmental influences.

In some embodiments, a first wall element, which separates the bypass channel and the measuring channel from one another at least in portions, has a wall height which is reduced at least in portions, so that a flow can pass over the first wall element at least in portions, and/or has a through-port, so that a flow can pass through the first wall element. The air mass sensor is alternatively or additionally distinguished in that a second wall element, which separates the bypass channel and an inlet of the duct from one another at least in portions, has a wall height which is reduced at least in portions, so that a flow can pass over the second wall element at least in portions, and/or has a through-port, so that a flow can pass through the second wall element.

The reduced wall height and/or the through-port therefore allow an additional fluid connection within the duct to provide an additional pressure compensation for the measuring channel. Also in this way, in particular, the amplitude of oscillation excitations due to high-frequency pressure pulsations of turbochargers can be reduced so that reliable measurement can also take place for critical excitation frequencies. In particular, natural frequencies of the duct can also be eliminated in this way or a respective oscillation response in the range of one or more natural frequencies can be reduced.

In some embodiments, the duct and the electronics chamber are connected to each other via a port, wherein the electronics chamber forms a pressure compensation volume for the duct. The port therefore enables a fluid connection between the duct and the electronics chamber, so that part of the air mass flow to be measured can flow out of the duct into the electronics chamber.

Also in this way, in particular, the amplitude of oscillation excitations due to high-frequency pressure pulsations of turbochargers can be reduced so that reliable measurement can also take place for critical excitation frequencies. In particular, natural frequencies of the duct can also be eliminated in this way or a respective oscillation response in the range of one or more natural frequencies can be reduced.

As another example, some embodiments include a motor vehicle comprising an air mass sensor as described herein. The motor vehicle can have an internal combustion engine, wherein the air mass sensor is arranged in an intake line of the internal combustion engine to measure an air mass flow within the intake line. The internal combustion engine can have one or more turbochargers.

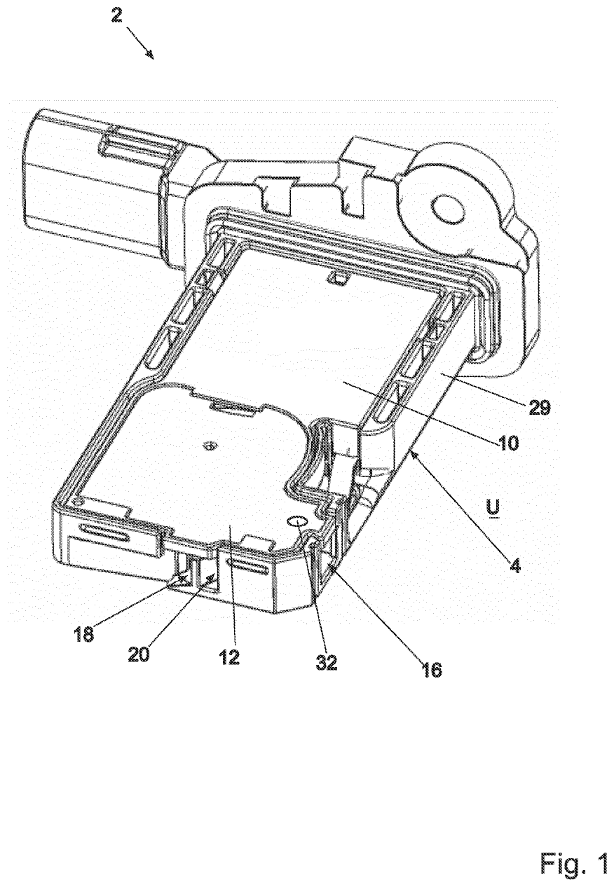

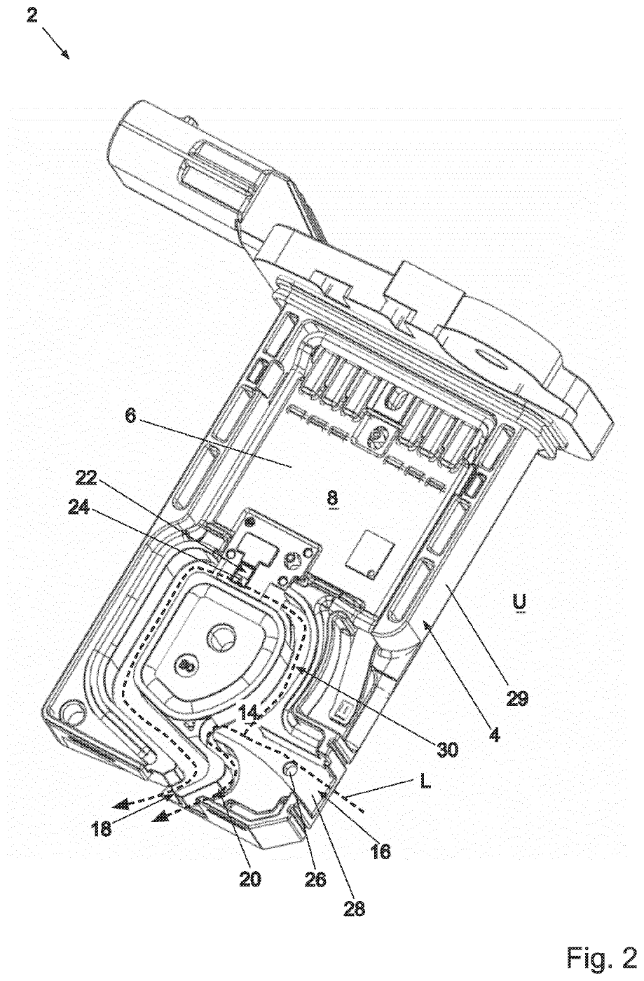

FIG. 1 shows an air mass sensor 2 incorporating teachings of the present disclosure for determining an air mass flow. The air mass sensor 2 has a housing 4. The air mass sensor 2 has sensor electronics 6, wherein the sensor electronics 6 is located in a housing or electronics chamber 8 of the housing 4 (FIG. 2). To illustrate the electronics chamber 8 and the sensor electronics 6, covers 10, 12 or lids 10, 12 of the housing 4 are hidden in FIG. 2.

The housing 4 has a duct 14 for passing through the housing 4 an air mass flow L to be measured. The duct 14 has an inlet port 16 for introducing the air mass flow L into the housing 4. The duct 14 has an outlet port 18 for discharging the air mass flow L from the housing 4.

The duct 14 has a bypass 20 or bypass channel 20, so that part of the air mass flow L does not flow to a measuring point 22 of the air mass sensor 2, but is branched off before the measuring point 22 and is led out of the housing 4 again.

A measuring element 24 of the sensor electronics 6 is arranged in the region of the measuring point 22. The measuring element 24 is a thermal measuring element 24—in this case a hot-film air mass measuring element 24.

In addition to the inlet port 16 and the outlet port 18 of the duct 14, the housing 4 has a compensation port 26 which connects the duct 14 to surroundings U of the housing 4. In other words, there is a fluid connection between the surroundings U and the duct 14 so that air of the air mass flow L can flow from the duct 14 into the surroundings U and can flow from the surroundings U into the duct 14.

In the present case, the compensation port 26 is a circular-cylindrical through-port 26, which is made in a wall 28 of a main body 29 of the housing 4.

In the present case, the compensation port 26 is arranged in the region of the inlet 16 of the duct 14 and is therefore arranged upstream of a branching of the duct 14, in the region of which the duct branches into a measuring channel 30 and the bypass channel 20. The compensation port 26 is therefore arranged at a distance from the bypass channel 20.

Another additional compensation port 32 is also provided in the cover 12 of the housing 4 and connects the duct 14 to the surroundings U of the housing 4.

Here, the cover 12 is a first housing part 12 of the housing, the main body 29 is a second housing part 29 of the housing 4, and the cover 10 is a third housing part 10 of the housing 4.

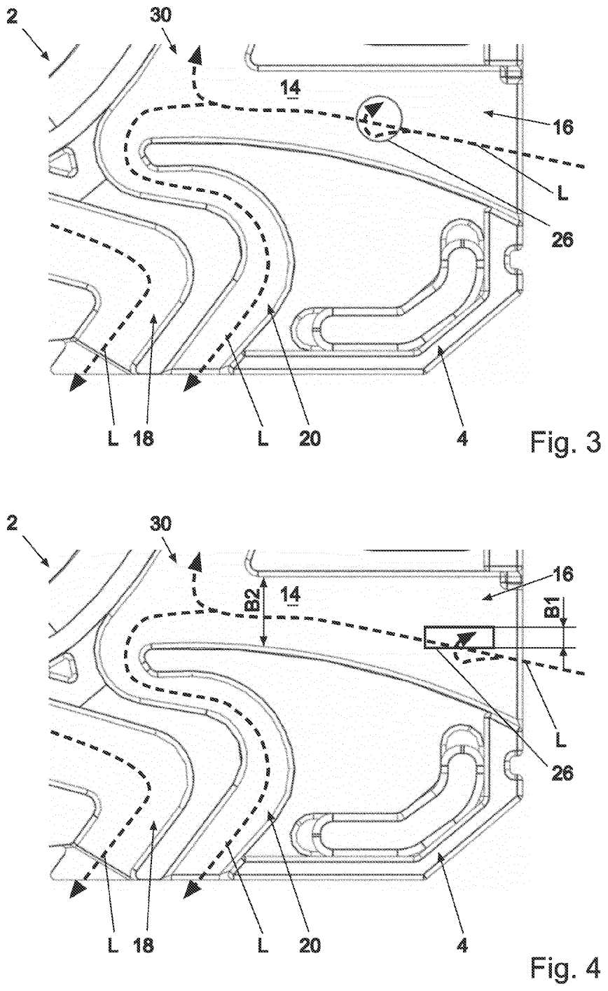

FIG. 3 shows an enlarged detail of the air mass sensor 2 according to FIG. 2 in a plan view.

The air mass flow L flowing into the inlet 16 can partially escape through the compensation port 26. This applies equally to the compensation port 32 (not shown) of the cover 12.

Subsequently, the duct 14 branches into the measuring channel 30, which leads to the measuring point 24, and the bypass channel 20, which bypasses the measuring point 24 and conducts part of the air mass flow L out of the housing 4 without supplying it to the measuring point 24. The air mass flow L supplied to the measuring point 24 via the measuring channel 30 and measured by the measuring element 24 is conducted out of the housing 4 via the outlet port 18 of the measuring channel 30.

FIGS. 4-8 show further exemplary embodiments of air mass sensors 2 incorporating teachings of the present disclosure, which differ from each other in the shape of the compensation port 26.

FIG. 4 shows an air mass sensor 2 with a narrow rectangular compensation port 26, wherein a width B1 of the compensation port 26 corresponds to less than one third of a minimum width B2 of the duct 14 before the duct 14 branches into the measuring channel 30 and the bypass channel 20.

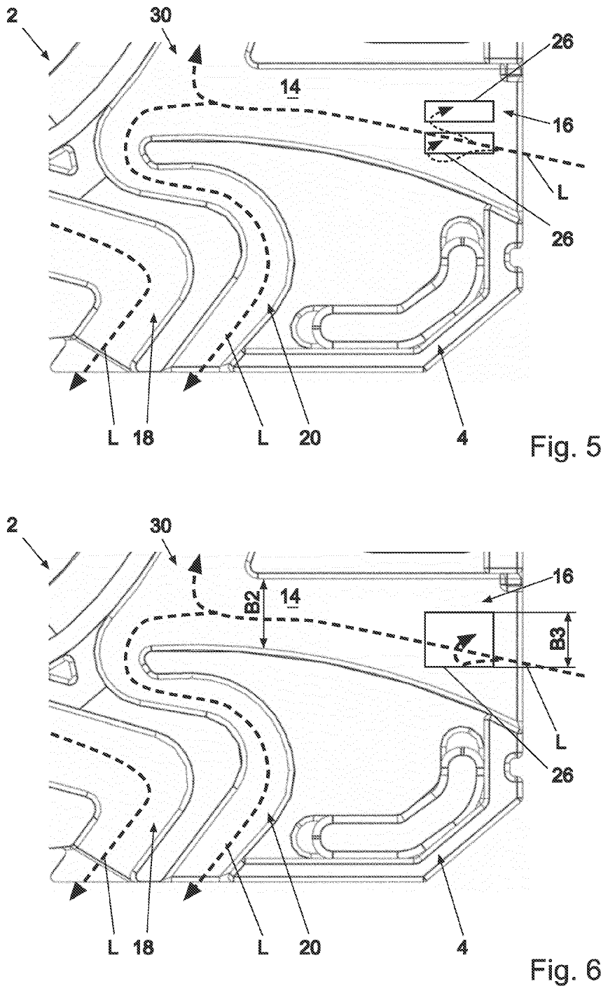

FIG. 5 shows an air mass sensor 2 with two narrow, rectangular compensation ports 26.

FIG. 6 shows an air mass sensor 2 with a wide, rectangular compensation port 26, wherein a width B3 of the compensation port 26 corresponds to more than one third of the minimum width B2 of the duct 14 before the duct 14 branches into the measuring channel 30 and the bypass channel 20.

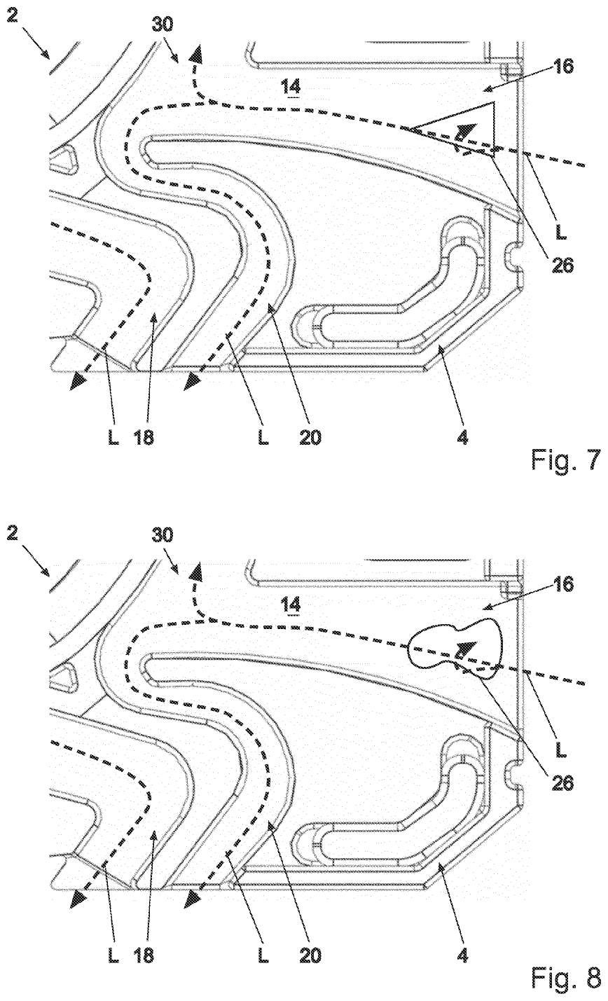

FIG. 7 shows an air mass sensor 2 with triangular compensation port 26.

FIG. 8 shows an air mass sensor 2 with a freely formed compensation port 26.

The selected shape of the compensation port 26 can be determined in tests and/or by means of simulations and adapted to the installation situation and the excitations in the fully assembled state, so that a reliable measurement can take place also for critical excitation frequencies. In particular, natural frequencies of the duct can be reduced or eliminated in this way.

In some embodiments, compensating ports 32 are made in the cover 12 and are designed in accordance with the compensating ports 26 according to FIGS. 4-8.

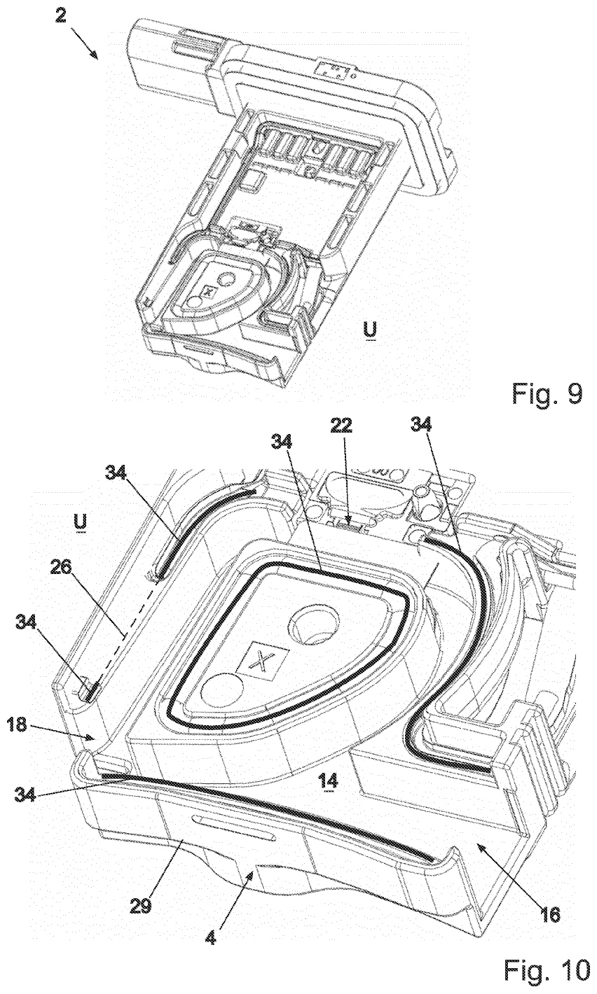

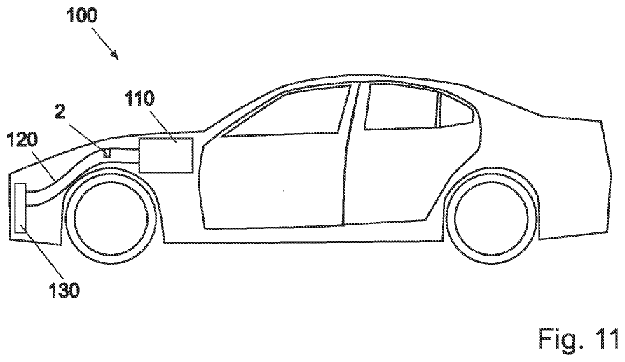

FIGS. 9 and 10 show a further embodiment of an air mass sensor 2 incorporating teachings of the present disclosure, which differs from the variant according to FIG. 1 in that no bypass is provided and the compensation port 26 is designed as an interruption of an adhesive seam 34. FIG. 10 shows an enlarged illustration of FIG. 9.

The adhesive seams 34 serve to join the cover 12 to the housing 4 and to seal the duct 14 in the bonded regions with respect to the surroundings U. In the region of the compensation port 26, the adhesive seam 34 shown on the left in the illustration is interrupted so that, when the cover 12 is assembled, part of the air mass flow L can escape through the compensation port 26 between the cover 12 and the main body 29 of the housing 4.

FIG. 11 shows a motor vehicle 100, with a turbocharged internal combustion engine 110 and with an air mass sensor 2 incorporating teachings of the present disclosure, wherein the air mass sensor 2 is arranged in an intake line 120 of the internal combustion engine 110 to measure an air mass flow within the intake line 120. The intake line 120 is connected to an intercooler 130.

In some embodiments, the motor vehicle 100 can be a hybrid vehicle having at least one electric motor with an associated traction battery in addition to the internal combustion engine 110.

What is claimed is:

1. An air mass sensor for determining an air mass flow rate, the sensor
comprising:
a housing defining a chamber;
sensor electronics
at least partly located in the chamber;
a duct passing an air mass flow through the housing to be measured, the duct comprising
an inlet port and an outlet port; and
at least one compensation port connecting the duct to surroundings external to the housing.

2. The air mass sensor as claimed in claim 1, wherein the compensation port is formed between two parts of the housing.

3. The air mass sensor as claimed in claim 2, wherein
the compensation port at least partially borders an adhesive connecting the two housing parts.

4. The air mass sensor as claimed in claim 3, wherein the compensation port is defined by an interrupted adhesive seam or interrupted adhesive bead.

5. The air mass sensor as claimed in claim 2, further comprising
a seal between the two housing parts;
wherein the compensation port at least partially borders the seal.

6. The air mass sensor as claimed in claim 5, wherein the compensation port is defined by the seal or the seal is at least partially interrupted to form the compensation port.

7. The air mass sensor as claimed in claim 1, wherein the compensation port is arranged upstream of a branching of the duct into a measuring channel and a bypass channel.

8. The air mass sensor as claimed in claim 1, wherein:
the compensation port has a polygonal shape, or
the compensation port has a circular or oval shape.

9. A motor vehicle comprising:
an internal combustion engine;
an air mass sensor for determining an air mass flow rate, the sensor comprising:
a housing defining a chamber;
sensor electronics at least partly located in the chamber;
a duct passing an air mass flow through the housing to be measured, the duct comprising an inlet port and an outlet port; and
at least one compensation port connecting the duct to surroundings external to the housing.

10. The motor vehicle as claimed in claim 9, wherein
the air mass sensor is arranged in an intake line of the internal combustion engine to measure an air mass flow within the intake line.
